(19) United States
(12) Patent Application Publication
(10) Pub. No.: US 2023/0176210 A1
(43) Pub. Date: Jun. 8, 2023

(54) WIRELESS COMMUNICATION CONTROL DEVICE, WIRELESS COMMUNICATION DEVICE, AND WIRELESS COMMUNICATION CONTROL METHOD

(71) Applicant: DENSO CORPORATION, Kariya-city (JP)

(72) Inventors: Yosuke OGI, Kariya-city (JP); Masayuki HOSHINO, Kariya-city (JP)

(21) Appl. No.: 18/165,092

(22) Filed: Feb. 6, 2023

Related U.S. Application Data
(63) Continuation of application No. PCT/JP21/30492, filed on Aug. 20, 2021.

(30) Foreign Application Priority Data
Sep. 14, 2020 (JP) 2020-153990

(51) Int. Cl. G01S 13/931; H04W 72/0446

(52) U.S. Cl. CPC G01S 13/931; H04W 72/0446; G01S 2013/9329

(57) ABSTRACT

By a wireless communication control device, a wireless communication device, or a wireless communication method, a vehicle speed of a vehicle is acquired, communication status information regarding a communication status in a communication range of an access point is acquired, a communication environment in the communication range of the access point is predicted based on the acquired communication status information.

### CROSS REFERENCE TO RELATED APPLICATIONS

The present application is a continuation application of International Patent Application No. PCT/JP2021/030492 filed on Aug. 20, 2021, which designated the U.S. and claims the benefit of priority from Japanese Patent Application No. 2020-153990 filed on Sep. 14, 2020. The entire disclosures of all of the above applications are incorporated herein by reference.

### TECHNICAL FIELD

The present disclosure relates to a wireless communication control device, a wireless communication device, and a wireless communication control method.

### BACKGROUND

It has been known that a wireless network is connected via a wireless communication with an access point of a wireless network, and information is transmitted and received. For example, as a comparative example, there is a technology that, before a wireless communication device of a subject vehicle reaches a forward position, predicts interference channels by using communication status information in order to avoid interference in advance.

### SUMMARY

By a wireless communication control device, a wireless communication device, or a wireless communication method, a vehicle speed of a vehicle is acquired, communication status information regarding a communication status in a communication range of an access point is acquired, a communication environment in the communication range of the access point is predicted based on the acquired communication status information.

### BRIEF DESCRIPTION OF DRAWINGS

FIG. 1 is a diagram showing one example of a schematic configuration of a vehicle communication system.

FIG. 2 is a diagram showing one example of schematic configurations of a vehicle unit and a wireless communication device.

FIG. 3 is a diagram for illustrating one example of a threshold range.

FIG. 4 is a flowchart showing an example of a flow of permission determination-related process in controller;

FIG. 5 is a diagram showing one example of schematic configurations of a vehicle unit and a wireless communication device.

FIG. 6 is a diagram for explaining one example of a correspondence relationship between a necessary information amount and threshold values that define the threshold range.

FIG. 7 is a diagram for explaining one example of the threshold range.

FIG. 8 is a diagram for explaining one example of the threshold range.

### DETAILED DESCRIPTION

However, the technology of the comparative example has a difficulty that unnecessary computation load increases. The details will be described as follows.

In the comparative example, it is not assumed that the interference channel is not predicted before the wireless communication device reaches the forward position of the subject vehicle. Accordingly, in the technology of the comparative example, even when it is useless to predict an interference channel at the forward position of the subject vehicle, it becomes wasteful to predict the interference channel. Wasteful prediction of the interference channel increases the wasteful computational load of the wireless communication device.

The present disclosure provides a wireless communication control device, a wireless communication device, and a wireless communication control method capable of reducing a wasteful calculation load while reducing an interference in a communication range of an access point of the wireless network.

According to one example, a wireless communication control device controls a wireless communication device. The wireless communication device is mounted on a vehicle and transmits and receives information via wireless communication with an access point of a wireless network. The wireless communication control device includes: a vehicle speed acquisition unit that acquires a vehicle speed of the vehicle; a communication status acquisition unit that acquires communication status information regarding a communication status in a communication range of the access point; and a prediction unit that predicts a communication environment in the communication range of the access point based on the communication status information acquired by the communication status acquisition unit. The prediction unit predicts the communication environment when the vehicle speed acquired by the vehicle speed acquisition unit is within a threshold range. The prediction unit does not predict the communication environment when the vehicle speed acquired by the vehicle speed acquisition unit is not within the threshold range.

According to another example, a wireless communication device is mounted on a vehicle and transmits or receives information via wireless communication with an access point of a wireless network. The device includes: a communication unit that performs the wireless communication with the access point; and the wireless communication control device.

Further, according to another example, a wireless communication control method is executed by at least one processor and controls a wireless communication device that is mounted on a vehicle and transmits and receives information via wireless communication with an access point of a wireless network. The method includes: acquiring a vehicle speed of the vehicle; acquiring communication status information regarding a communication status in a communication range of the access point; predicting a communication environment in the communication range of the access point based on the acquired communication status information; predicting the communication environment when the acquired vehicle speed is within a threshold range; and

executing no prediction of the communication environment when the acquired vehicle speed is not within the threshold range.

According to the above configurations, when the vehicle speed of the vehicle is within the threshold range, the communication environment within the communication range of the access point is predicted based on the communication status information regarding the communication status within the communication range of the access point. Therefore, it may be possible to reduce the interference within the communication range of the access point of the wireless network.

On the other hand, when the vehicle speed is not within the threshold range, the communication environment within the communication range of the access point is not predicted. Therefore, when the vehicle speed of the vehicle is not within the communication range, it may be possible to reduce a calculation load caused by the prediction of the communication environment. When the vehicle speed becomes too fast, it becomes difficult to transmit and receive the information at the time of passing through the communication range of the access point. Accordingly, it is considered useless to predict the communication environment within the communication range when the vehicle speed is too fast. Further, when the vehicle speed becomes sufficiently slow, it is considered that there will be an allowance for transmitting and receiving information at the time of passing through the communication range of the access point without predicting the communication environment within the communication range. Accordingly, it is considered useless to predict the communication environment within the communication range when the vehicle speed is sufficiently slow. On the other hand, when the vehicle speed of the vehicle is not within the threshold range, the communication environment within the communication range of the access point is not predicted. Therefore, at least, it may be possible to prevent the above-described waste from occurring and reduce the wasteful calculation load caused by the prediction of the communication environment. As a result, it may be possible to reduce unnecessary calculation load while reducing the interference within the communication range of the access point of the wireless network.

Further, according to the present disclosure, the wireless communication device is mounted on a vehicle, and transmits and receives information via wireless communication with the access point of the wireless network. The wireless communication device includes a communication unit that wirelessly communicates with the access point and the wireless communication control device described above.

According to this, since the wireless communication control device described above is included, it may be possible to reduce the wasteful calculation load while reducing the interference within the communication range of the access point of the wireless network.

Multiple embodiments will be described with reference to the drawings. For convenience of description, among multiple embodiments, a configuration having the same function as a configuration shown in the drawing and described in the previous embodiment may be indicated by the same reference symbol, and the description thereof may be omitted. For the configuration having the same reference symbol as in the previous embodiment, detailed description may be omitted in other embodiments.

### First Embodiment

### <Schematic Configuration of Vehicle Communication System>

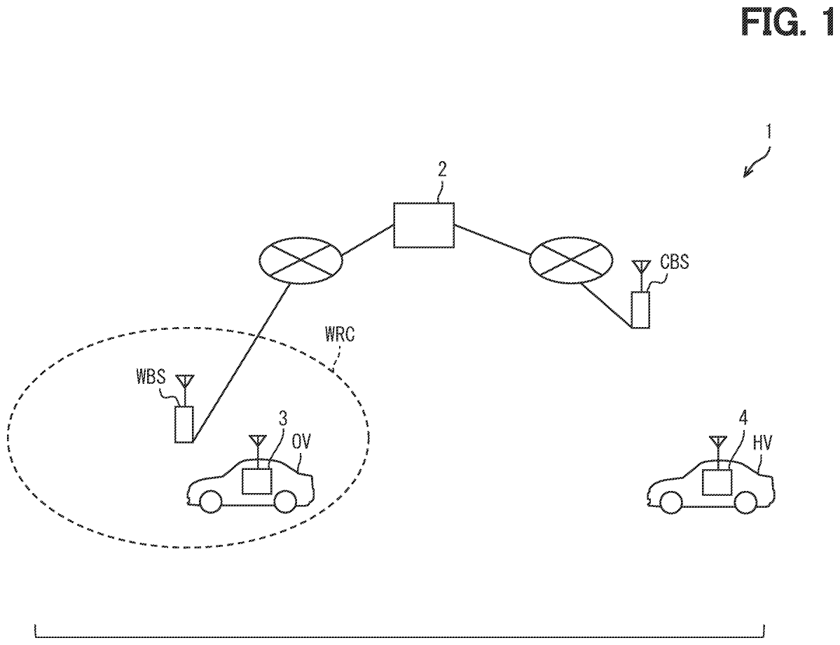

Hereinafter, a present embodiment will be described with reference to the drawings. First, a vehicle communication system 1 will be described with reference to FIG. 1. As shown in FIG. 1, the vehicle communication system 1 includes a server 2, a wireless communication device 3 used for a vehicle OV, and a vehicle unit 4 used for a vehicle HV. It is assumed that the vehicle HV is the subject vehicle. It is assumed that the vehicle OV is a different vehicle other than the subject vehicle. Multiple vehicles OV may be provided. Alternatively, the vehicle communication system 1 may not include the wireless communication device 3. WBS in FIG. 1 indicates a base station for Wi-Fi (registered trademark). That is, the base station WBS corresponds to a Wi-Fi access point. The Wi-Fi access point can be also referred to as a Wi-Fi spot. A WRC in FIG. 1 indicates a communication range of the base station WBS. A CBS in FIG. 1 indicates a base station for cellular communication.

The server 2 receives data transmitted from the vehicle unit 4. Further, the server 2 transmits data to the vehicle unit 4. The server 2 may be provided by one server or multiple servers. For example, a server 2 receiving the data from the vehicle unit 4 may be different from a server 2 transmitting data to the vehicle unit 4. The server 2 may be, for example, a server on the cloud or a distributed network such as a block chain.

The wireless communication device 3 can perform communication by connecting to at least the Wi-Fi network. That is, the wireless communication device 3 connects with the Wi-Fi network by performing wireless communication with the base station WBS in accordance with a communication standard of a wireless LAN corresponding to the Wi-Fi in a communication range WRC of the base station WBS. The wireless communication device 3 acquires, in the communication range WRC, information related to communication status indicating a radio wave used in the communication range WRC or the like by using, for example, channel scan or the like. Further, it is assumed that the wireless communication device 3 can transmit information related to the acquired communication status by, for example, the inter-vehicle communication.

The vehicle unit 4 performs data communication with the server 2. The vehicle unit 4 transmits, for example, data obtained by traveling of the subject vehicle HV to the server 2. Examples of the data transmitted to the server 2 include data of a captured image obtained by a surrounding monitoring camera of the subject vehicle, or the like. Such the captured image data is used for map generation, machine learning, or the like. Further, the vehicle unit 4 receives data necessary for the subject vehicle HV from the server 2. Examples of the data received from the server 2 include update data of a firmware of an ECU of the subject vehicle HV or the like. Details of the vehicle unit 4 will be described below.

### <Schematic Configuration of Vehicle Unit>

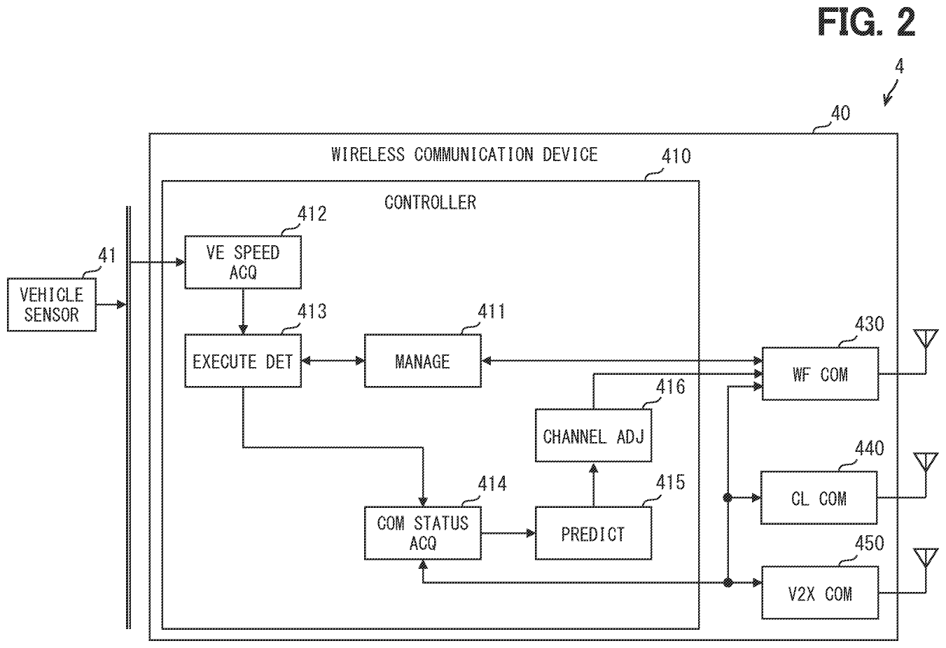

Next, a schematic configuration of the vehicle unit 4 will be described with reference to FIG. 2. As shown in FIG. 2, the vehicle unit 4 includes a wireless communication device 40 and a vehicle speed sensor 41. Hereinafter, a vehicle on which the vehicle unit 4 is mounted is referred to as the subject vehicle. The wireless communication device 40 and the vehicle speed sensor 41 may be connected to each other via an in-vehicle LAN, for example.

The vehicle speed sensor 41 is a sensor that detects the vehicle speed of the subject vehicle HV. The vehicle speed sensor 41 outputs the detected vehicle speed to the in-vehicle LAN. Note that the vehicle speed detected by the vehicle speed sensor 41 may be output to the in-vehicle LAN via the ECU mounted on the subject vehicle HV.

The wireless communication device 40 transmits and receives information via the wireless communication. The wireless communication device 40 communicates with the server 2 via a public communication network, a base station, and the like. Further, the wireless communication device 40 communicates with the wireless communication device 3 of the different vehicle OV via the inter-vehicle communication, and communicates with a roadside device via road-to-vehicle communication. Details of the wireless communication device 40 will be described below.

### <Schematic Configuration of Wireless Communication Device>

Next, a schematic configuration of the wireless communication device 40 will be described with reference to FIG. 2. As shown in FIG. 2, the wireless communication device 40 includes the controller 410, a Wi-Fi communication unit (hereinafter, WF communication unit) 430, a cellular communication unit (hereinafter, CL communication unit) 440, and a V2X communication unit 450. In the drawings, the WF communication unit 430 may be also referred to as “WF COM”, the CL communication unit 440 may be also referred to as “CL COM”, and the V2X communication unit 450 may be also referred to as “V2X COM”.

The WF communication unit 430 communicates with the server 2 via the base station WBS of the Wi-Fi and the internet. That is, the WF communication unit 430 communicates with the server 2 by connecting to the Wi-Fi network. This communication is hereinafter referred to as Wi-Fi communication. The Wi-Fi communication is possible within the communication range WRC of the base station WBS.

The CL communication unit 440 communicates with the server 2 via the base station CBS of the cellular communication and the internet. That is, the CL communication unit 440 communicates with the server 2 by connecting to a cellular network. This communication is referred to as cellular communication. The cellular communication includes communication using cellular lines such as LTE (Long Term Evolution) and 5G.

The V2X communication unit 450 communicates with the wireless communication device 3 of the different vehicle OV via the inter-vehicle communication, and communicates with the roadside device via the road-to-vehicle communication. These communications are hereinafter referred to as V2X communication. The inter-vehicle communication may be inter-vehicle communication using the 5.8 GHz band or inter-vehicle communication using the 700 MHz band. A communication distance of inter-vehicle communication using the 5.8 GHz band is about several tens of meters. A communication distance of inter-vehicle communication using the 700 MHz band is about several hundred meters.

The controller 410 includes, for example, a processor, a memory, an I/O, and a bus connecting these components, and executes various processes related to transmission and reception of data by executing a control program stored in the memory. The memory referred to here is a non-transitory tangible storage medium, and stores programs and data that can be read by a computer. The non-transitory tangible storage medium is implemented by a semiconductor memory or the like. Details of the controller 410 will be described below.

### <Schematic Configuration of Controller>

Next, a schematic configuration of the controller 410 will be described with reference to FIG. 2. As shown in FIG. 2, the controller 410 includes a management unit 411, a vehicle speed acquisition unit 412, an execution determination unit 413, a communication status acquisition unit 414, a prediction unit 415, and a channel adjustment unit 416 as functional blocks. A part or all of the functions executed by the controller 410 may be configured in hardware by one or multiple ICs or the like. A part or all of the functional blocks included in the controller 410 may be implemented by executing software by a processor and a combination of hardware members. This controller 410 corresponds to a wireless communication control device. Execution of the process of each functional block of the controller 410 by the computer corresponds to execution of the wireless communication control method. In the drawings, the management unit 411 may be also referred to as “MANAGE”, the vehicle speed acquisition unit 412 may be also referred to as “VE SPEED ACQ”, the execution determination unit 413 may be also referred to as “EXECUTE DET”, the communication status acquisition unit 414 may be also referred to as “COM STATUS ACO”, the prediction unit 415 may be also referred to as “PREDICT”, and the channel adjustment unit 416 may be also referred to as “CHANNEL ADJ”.

The management unit 411 manages data transmitted and received by the wireless communication device 40. For example, the management unit 411 holds, in a volatile memory, data to be transmitted by the wireless communication device 40. Further, the management unit 411 holds, in the volatile memory, information requested to be received by the wireless communication device 40. The information requested to be received by the wireless communication device 40 may be information such as the capacity of firmware update data of an ECU of the subject vehicle HV, for example.

The vehicle speed acquisition unit 412 acquires the vehicle speed of the subject vehicle HV. The vehicle speed acquisition unit 412 may acquire the vehicle speed of the subject vehicle HV detected by the vehicle speed sensor 41. The process by this vehicle speed acquisition unit 412 corresponds to a vehicle speed acquisition process.

The execution determination unit 413 determines whether to operate the communication status acquisition unit 414 and the prediction unit 415, and switches between permission and prohibition of the operation. It is preferable that the execution determination unit 413 does not operate the communication status acquisition unit 414 and the prediction unit 415 when there is no information that needs to be transmitted or received by the wireless communication device 40. The information that needs to be transmitted or received by the wireless communication device 40 can be rephrased as information required to be transmitted or received. When the execution determination unit 413 does not hold information that needs to be transmitted or received by the management unit 411, the execution determination unit 413 may determine that there is no information required to be transmitted or received. The execution determination unit 413 may inquire of the management unit 411 about the presence or absence of information that needs to be transmitted or received. When the management unit 411 holds information that needs to be transmitted or received, it may be determined that there is information to be transmitted or received.

The execution determination unit 413 switches between permission or prohibition of the operation of the communication status acquisition unit 414 and the prediction unit 415 according to the vehicle speed of the subject vehicle HV acquired by the vehicle speed acquisition unit 412. The execution determination unit 413 switches between permission or prohibition of the operation of the communication status acquisition unit 414 and the prediction unit 415, according to whether the vehicle speed of the subject vehicle HV is within the threshold range.

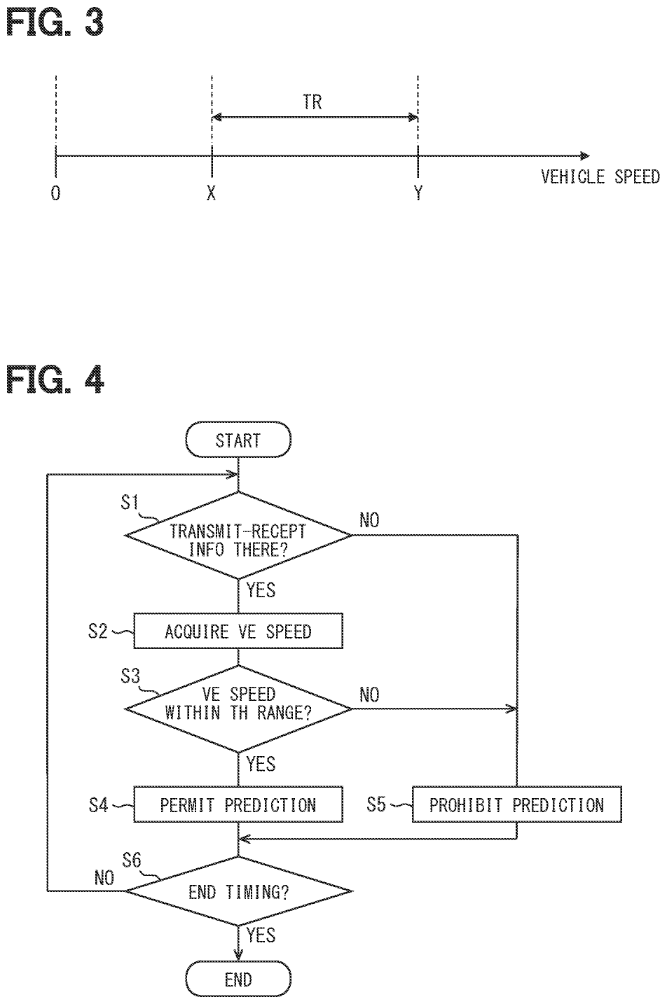

The threshold range may be a range between two thresholds of an upper limit value and a lower limit value. Here, with reference to FIG. 3, one example of the threshold range will be described. An X in FIG. 3 represents the lower limit value. A Y in FIG. 3 represents the upper limit value. The threshold range is equal to or greater than the lower limit value X and equal to or less than the upper limit value Y (see TR in FIG. 3). The vehicle speed of 0 or more and less than the lower limit value X is out of the threshold range. Further, the vehicle speed greater than the upper limit value Y is out of the threshold range.

The lower limit value X may be set to a value for discriminating the value from the low-speed value estimated to generate allowance for transmitting or receiving information at the time of passing through this communication range without prediction of the communication environment within the communication range of the access point of the wireless network. In other words, this lower limit value X may be set to a lower limit value for discriminating the value from the low-speed value that causes estimation that there is a high possibility to generate allowance for transmitting or receiving information even when the transmission or reception is performed in a case where the interference is eliminated without change of channel after prediction of the frequency channel with less interference. In the present embodiment, the wireless network whose communication environment is to be predicted (hereinafter referred to as target network) is assumed to be a Wi-Fi network. Further, the upper limit value Y may be set to an upper limit value for distinguishing the value from a high speed value causing estimation that there is no allowance for transmitting or receiving the information required to be transmitted or received at the time of passing through the communication range of an access point (hereinafter, Wi-Fi spot) of the Wi-Fi network. In this embodiment, the lower limit value X and the upper limit value Y are assumed to be set as fixed values.

The execution determination unit 413 permits the operation of the communication status acquisition unit 414 and the prediction unit 415 when the vehicle speed of the subject vehicle HV is within the threshold range. That is, when the vehicle speed of the subject vehicle HV is equal to or more than the lower limit value X and also is equal to or less than the upper limit value Y, the execution determination unit 413 permits the operation of the communication status acquisition unit 414 and the prediction unit 415. On the other hand, the execution determination unit 413 prohibits the operation of the communication status acquisition unit 414 and the prediction unit 415 when the vehicle speed of the subject vehicle HV is not within the threshold range. That is, when the vehicle speed of the subject vehicle HV is less than the lower limit value X or more than the upper limit value Y, the execution determination unit 413 prohibits the operation of the communication status acquisition unit 414 and the prediction unit 415.

The communication status acquisition unit 414 acquires, via the wireless communication, the communication status information regarding the communication status in the communication range of the Wi-Fi spot when the execution determination unit 413 permitted the operation. On the other hand, the communication status acquisition unit 414 does not acquire the communication status information when the execution determination unit 413 has prohibited the operation. The process by this communication status acquisition unit 414 corresponds to a communication status acquisition process.

The communication status acquisition unit 414 may acquire the communication status information about the Wi-Fi spot to be passed through. The Wi-Fi spot to be passed through may be identified from, for example, the vehicle position of the subject vehicle HV and the position of the Wi-Fi spot. As the vehicle position of the subject vehicle HV, a position measured by a locator mounted on the subject vehicle HV may be used. The position of the Wi-Fi spot may be identified from map data stored in a map database mounted on the subject vehicle, or may be acquired from the server 2. The position of the Wi-Fi spot may be acquired from the server 2 via any of the WF communication unit 430, the CL communication unit 440, and the V2X communication unit 450. The communication status acquisition unit 414 may acquire the communication status information, for example, when the execution determination unit 413 permits the operation and also the vehicle comes close to the communication range of the Wi-Fi spot to be passed through. Thereby, it may be possible to predict the frequency channel that reduces the interference and avoid the interference before the vehicle reaches the communication range of the Wi-Fi spot.

The communication status information acquired by the communication status acquisition unit 414 may be, for example, the number of communicating terminals within the communication range of the Wi-Fi spot to be passed (hereinafter, target communication range), channels in use, electric field intensity of each channel, and the like. The communication status information may be any information that can identify the communication status in the target communication range. The communication status acquisition unit 414 may acquire communication status information via any of the WF communication unit 430, the CL communication unit 440, and the V2X communication unit 450.

When the communication status acquisition unit 414 acquires communication status information via the WF communication unit 430, the following may be done. The communication status acquisition unit 414 may perform the wireless communication with the Wi-Fi spot corresponding to the target communication range after entering the target communication range, and acquire the communication status information via the WF communication unit 430.

When the communication status acquisition unit 414 acquires communication status information via the CL communication unit 440, the following may be done. For example, the communication status acquisition unit 414 causes the CL communication unit 440 to download the communication status information about the target communication range by sending, for example, position information of the Wi-Fi spot corresponding to target communication range from the CL communication unit 440 to the server 2. Note that, in a case of employing this configuration, the server 2 sequentially collects and holds the communication status information about each Wi-Fi spot of the Wi-Fi network.

When the communication status acquisition unit 414 acquires communication status information via the V2X communication unit 450, the following may be done. The communication status acquisition unit 414 causes the V2X communication unit 450 to receive communication status information about the target communication range through the inter-vehicle communication. Then, the communication status acquisition unit 414 may acquire the communication status information received by the V2X communication unit 450. When the communication status information is acquired via the V2X communication unit 450, the communication status acquisition unit 416 may acquire the communication status information about the target communication range from the wireless communication device 3 of the different vehicle OV that is performing the Wi-Fi communication with the Wi-Fi spot corresponding to the target communication range, by acquiring the communication status information via the inter-vehicle communication using 5.8 GHz that enables relatively short distance communication.

The prediction unit 415 predicts the communication environment in the target communication range by using the communication status information that is acquired by the communication status acquisition unit 414 and is related to the target communication range. The prediction unit 415 predicts the communication environment when the execution determination unit 413 permits the operation. The prediction unit 415 may predict the communication environment when the execution determination unit 413 permits the operation, by predicting the communication environment in the case where the communication status acquisition unit 414 acquires the communication status information. On the other hand, the prediction unit 415 does not predict the communication environment when the execution determination unit 413 prohibits the operation. The prediction unit 415 may not predict the communication environment when the execution determination unit 413 prohibits the operation, without predicting the communication environment in the case where the communication status acquisition unit 414 does not acquire the communication status information. This process by the prediction unit 415 corresponds to a prediction process.

The prediction unit 415 may predict the frequency channel with less interference by the wireless communication in the target communication range as, for example, the communication environment. In one example, a channel that is not in use may be predicted as the frequency channel with less interference. Further, when there is channel in use, the channel with the lowest electric field intensity may be predicted as the frequency channel with less interference.

The channel adjustment unit 416 instructs the WF communication unit 430 to perform the Wi-Fi communication by using the channel predicted by the prediction unit 415 as the frequency channel with less interference. Thereby, it may be possible to predict the frequency channel with less interference in the target communication range.

### <Permission Determination-Related Process>

Next, with reference to a flowchart of FIG. 4, one example of a flow of a process (hereinafter, permission determination-related process) that is executed by the controller 410 and is related to determination of whether to permit or prohibit the prediction of the communication environment. The flowchart of FIG. 4 may start when a switch (hereinafter, power switch) for starting an internal combustion engine of the subject vehicle HV or a motor generator is turned on.

First, in S1, the execution determination unit 413 inquires of the management unit 411 about the presence or absence of information that needs to be transmitted or received. When there is information required be transmitted or received (YES in S1), the process shifts to S2. On the other hand, when there is no information required to be transmitted or received (NO in S1), the process shifts to S5. In S2, the vehicle speed acquisition unit 412 acquires the vehicle speed of the subject vehicle HV. In the drawings, the information required to be transmitted or received is shown as transmission reception information.

In S3, the execution determination unit 413 determines whether the vehicle speed acquired in S2 is within the threshold range. Then, when the vehicle speed is within the threshold range (YES in S3), the process shifts to S4. On the other hand, when the vehicle speed is not within the threshold range (NO in S3), the process shifts to S5.

In S4, the execution determination unit 413 permits the operation of the communication status acquisition unit 414 and the prediction unit 415, and the process shifts to S6. That is, the prediction of the communication environment is permitted, and the process shifts to S6. On the other hand, in S5, the execution determination unit 413 prohibits the operation of the communication status acquisition unit 414 and the prediction unit 415, and the process shifts to S6. That is, the prediction of the communication environment is prohibited, and the process shifts to S6.

In S6, when it is the end timing of the permission determination-related process (YES in S6), the permission determination-related process ends. On the other hand, when it is not the timing of the permission determination-related process (NO in S6), the process repeats. One example of the end timing of the permission determination-related process is a timing when the power switch is turned off.

### Overview of First Embodiment

According to the first embodiment, when the vehicle speed of the subject vehicle HV is within the threshold range, the communication environment within the communication range of the Wi-Fi spot is predicted based on the communication status information regarding the communication status within the communication range of the Wi-Fi spot. Therefore, it may be possible to reduce the interference within the communication range of the Wi-Fi spot.

On the other hand, when the vehicle speed of the subject vehicle HV is not within the threshold range, the communication environment within the communication range of the Wi-Fi spot is not predicted by the prediction unit 415. Therefore, when the vehicle speed of the subject vehicle HV is not within the communication range, it may be possible to reduce the calculation load caused by the prediction of the communication environment. When the vehicle speed becomes too fast, it becomes difficult to transmit and receive the information at the time of passing through the communication range of the Wi-Fi spot. Accordingly, it is considered useless to predict the communication environment within the communication range when the vehicle speed is too fast. Further, when the vehicle speed becomes sufficiently slow, it is considered that there will be an allowance for transmitting and receiving information at the time of passing through the communication range of the Wi-Fi spot without predicting the communication environment within the communication range. Accordingly, it is considered useless to predict the communication environment within the communication range when the vehicle speed is sufficiently slow. On the other hand, according to the configuration of the first embodiment, when the vehicle speed of the subject vehicle HV is not within the threshold range that is equal to or more that the lower limit value X and also equal to or less than the upper limit value Y, the prediction unit 415 does not predict the communication environment within the communication range of the Wi-Fi spot. Therefore, it may be possible to prevent the occurrence of any of the wastes described above and reduce the wasteful calculation load. As a result, it may be possible to reduce unnecessary calculation load while reducing the interference within the communication range of the access point of the wireless network.

Further, according to the first embodiment, when the vehicle speed of the subject vehicle HV is not within the threshold range, the communication status acquisition unit 414 does not acquire the communication status information. Therefore, it may be possible to reduce the calculation load and the communication load that are caused by acquisition of wasteful information.

In addition, since the threshold range is fixed in the configuration of the first embodiment, it may be possible to reduce the calculation caused by sequentially setting the threshold range. Therefore, the configuration may be easily applied when the performance of a calculation device such as a processor used in the wireless communication device 40 is relatively low.

### Second Embodiment

Although the configuration in which the threshold range is fixed is shown in the first embodiment, the configuration is not necessarily limited to this. For example, a configuration (hereinafter, second embodiment) may be adopted in which the threshold range is set according to the amount of information required to be transmitted or received. Hereinafter, one example of the second embodiment will be described with reference to the drawings.

The vehicle communication system 1 of the second embodiment is the similar to the vehicle communication system 1 of the first embodiment, except that a vehicle unit 4a is included instead of the vehicle unit 4.

### <Schematic Configuration of Vehicle Unit>

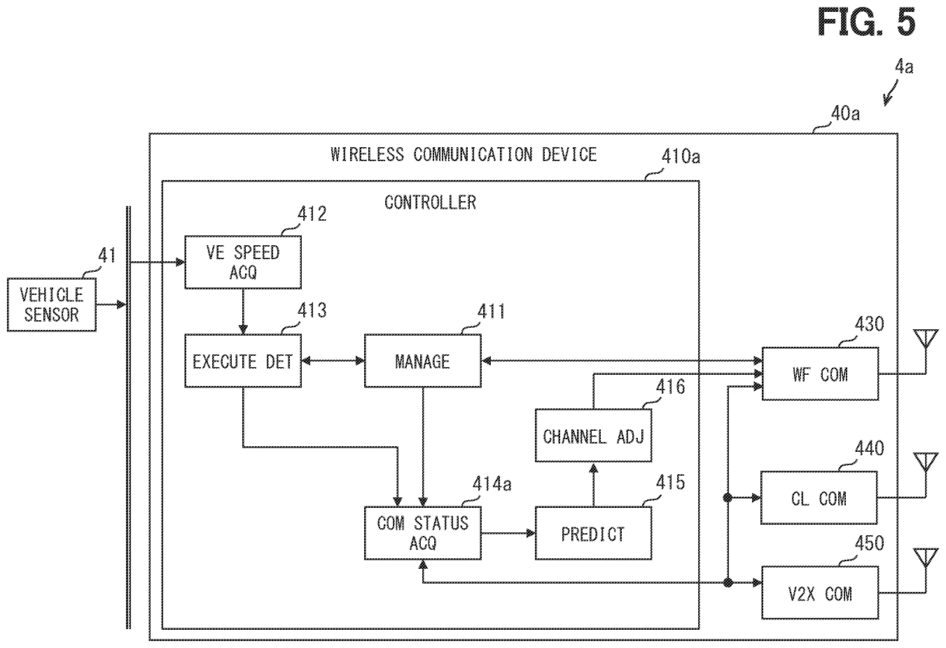

First, a schematic configuration of the vehicle unit 4a will be described with reference to FIG. 5. As shown in FIG. 5, the vehicle unit 4a includes a wireless communication device 40a and a vehicle speed sensor 41. The vehicle unit 4a is the similar to the vehicle unit 4 of the first embodiment except that the vehicle unit 4a includes a wireless communication device 40a instead of the wireless communication device 40.

### <Schematic Configuration of Wireless Communication Device>

Next, a schematic configuration of the wireless communication device 40a will be described with reference to FIG. 5. As shown in FIG. 5, the wireless communication device 40a includes a controller 410a, the WF communication unit 430, the CL communication unit 440, and the V2X communication unit 450. The wireless communication device 40a is similar to the wireless communication device 40 of the first embodiment, except that the wireless communication device 40a includes the controller 410a instead of the controller 410.

### <Schematic Configuration of Controller>

Next, a schematic configuration of the controller 410a will be described with reference to FIG. 5. As shown in FIG. 5, the controller 410a includes a management unit 411, a vehicle speed acquisition unit 412, an execution determination unit 413a, a communication status acquisition unit 414, a prediction unit 415, and a channel adjustment unit 416 as functional blocks. The controller 410a is similar to the controller 410 according to the first embodiment, except that the execution determination unit 413a is included instead of the execution determination unit 413. This controller 410a also corresponds to the wireless communication control device. Execution of each functional block of the controller 410a by the computer also corresponds to execution of the wireless communication control method.

The execution determination unit 413a is similar to the execution determination unit 413 according to the first embodiment, except that the threshold range is set according to the amount of information that needs to be transmitted or received by the wireless communication device 40. The execution determination unit 413a may inquire of the management unit 411 about the information amount (hereinafter, necessary information amount) of the information that needs to be transmitted or received by the wireless communication device 40, and may acquire the information amount.

The execution determination unit 413a may set the threshold value defining the threshold range to be a lower value as the necessary information amount increases, when there is the information that needs to be transmitted or received by the wireless communication device 40. That is, the lower limit value X and the upper limit value Y may be set to the lower value as the necessary information amount increases. The reason for setting the lower limit value X to a lower value as the necessary information amount increases is that, as the necessary information amount increases, at the time of passing through the communication range, the allowance for transmission or reception of information is less likely to occur at the low vehicle speed, even when the communication environment within the communication range of the Wi-Fi spot is not predicted. The reason why the upper limit value Y is set to the lower value as the necessary information amount increases is that, as the necessary information amount increases, it becomes difficult to transmit or receive the information required to be transmitted or received at the time of passing through the communication range of the Wi-Fi spot even at a lower vehicle speed.

On the other hand, the execution determination unit 413a may set the threshold value defining the threshold range to a higher value as the necessary information amount decreases, when there is the information that needs to be transmitted or received by the wireless communication device 40. That is, the lower limit value X and the upper limit value Y may be set to the higher value as the necessary information amount decreases. The reason for setting the lower limit value X to the higher lower value as the necessary information amount decreases is that, as the necessary information amount increases, at the time of passing through the communication range, the allowance for transmission or reception of information is more likely to occur at the high vehicle speed, even when the communication environment within the communication range of the Wi-Fi spot is not predicted. The reason why the upper limit value Y is set to the higher value as the necessary information amount decreases is that, as the necessary information amount increases, it becomes easy to transmit or receive the information required to be transmitted or received at the time of passing through the communication range of the Wi-Fi spot even at a higher vehicle speed.

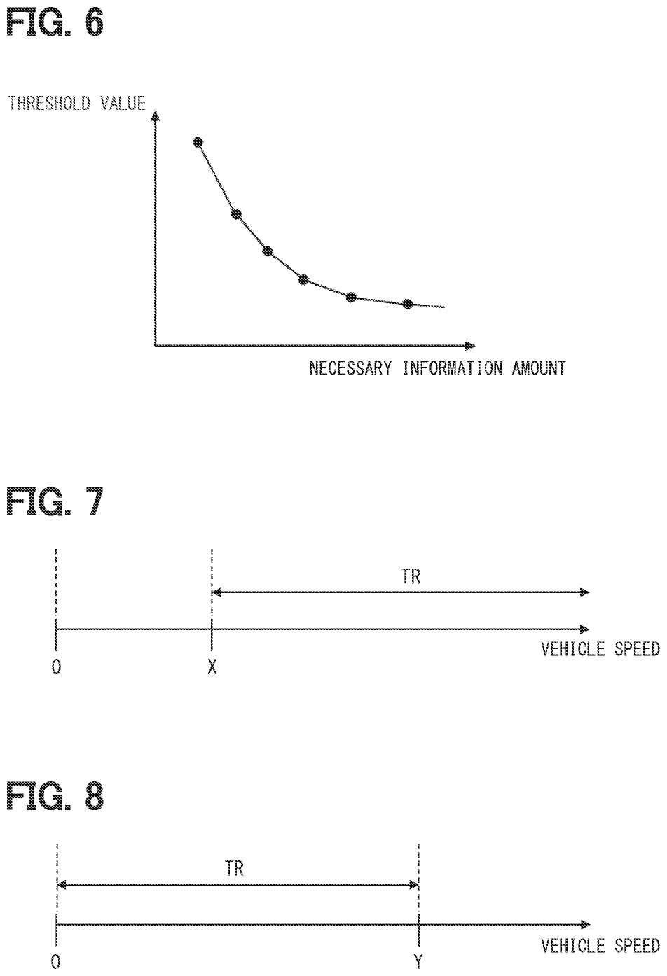

The correspondence relationship between the necessary information amount and the threshold value defining the threshold range may be a non-linear relationship in which the threshold value decreases as the necessary information amount increases, as shown in FIG. 6, for example. This correspondence relationship may be stored in advance as, for example, a map in the non-volatile memory of the controller 410a so that the execution determination unit 413a can use this correspondence relationship. Different maps may be used for the lower limit value X and the upper limit value Y, respectively. Note that the correspondence relationship between the necessary information amount and the threshold value that defines the threshold range may be a linear relationship.

### Overview of Second Embodiment

Even the configuration of the second embodiment is the similar to that of the first embodiment, except for the difference in whether the threshold range is fixed or variable. Therefore, similarly to the first embodiment, it may be possible to reduce the wasteful calculation load while reducing the interference in the communication range of the access point of the wireless network.

Further, according to the configuration of the second embodiment, the threshold range is set according to whether the necessary information amount is large or small. Therefore, it may be possible to set, with high accuracy, the threshold range so that prediction of the communication environment within the target communication range becomes waste. Thereby, it may be possible to further reduce the wasteful calculation load.

### Third Embodiment

In the above-described embodiments, the configuration in which the number of threshold values defining the threshold range is two of the lower limit value and the upper limit value, has been described as an example. However, the present disclosure is not necessarily limited to this. For example, a configuration (hereinafter, third embodiment) may be adopted in which the threshold value defining the threshold range is only the lower limit value of the lower and upper limit values.

In the case of the configuration according to the third embodiment, as shown in FIG. 7, a range equal to or more than the lower limit value X is a threshold range TR. In this case, when the vehicle speed of the subject vehicle HV is equal to or more than the lower limit value X, the vehicle speed of the subject vehicle HV is within the threshold range. Note that the lower limit value X may be set to 0. In this case, the execution determination units 413 and 413a do not permit prediction of the communication environment while the subject vehicle HV is stopped. On the other hand, the execution determination units 413 and 413a permit prediction of the communication environment while the subject vehicle HV travels.

Even in the configuration according to the third embodiment, when the vehicle speed is sufficiently slow, it may be possible to prevent wasteful prediction of the communication environment within the communication range and reduce the wasteful calculation load. As a result, it may be possible to reduce unnecessary calculation load while reducing the interference within the communication range of the access point of the wireless network.

### Fourth Embodiment

In the third embodiment, the configuration, in which the number of threshold values defining the threshold range is one of only the lower limit value of the upper and lower limit values, has been described as the example. However, the present disclosure is not necessarily limited to this. For example, a configuration (hereinafter, fourth embodiment) may be adopted in which the threshold value that defines the threshold range is only the upper limit value of the lower and upper limit values.

In the case of the configuration according to the fourth embodiment, as shown in FIG. 8, a range equal to or less than the upper limit value Y is the threshold range TR. In this case, since there is no vehicle speed equal to or less than 0, the vehicle speed of the subject vehicle HV is within the threshold range when the vehicle speed of the subject vehicle HV is equal to or more than 0 and also equal to or less than the upper limit value Y.

Even in the configuration according to the fourth embodiment, when the vehicle speed is too fast, it may be possible to prevent wasteful prediction of the communication environment within the communication range and reduce the wasteful calculation load. As a result, it may be possible to reduce unnecessary calculation load while reducing the interference within the communication range of the access point of the wireless network.

### Fifth Embodiment

In the above-described embodiments, the configuration, in which the execution determination units 413 and 413a prohibit the operation of the communication status acquisition unit 414 and the prediction unit 415 when the vehicle speed of the subject vehicle HV is not within the threshold range, has been described. However, the present disclosure is not necessarily limited to this. For example, a configuration (hereinafter, fifth embodiment), in which the execution determination units 413 and 413a prohibit the operation of the prediction unit 415 and do not prohibit the operation of the communication status acquisition unit 414 when the vehicle speed of the subject vehicle HV is not within the threshold range, may be employed.

Even in the configuration according to the fifth embodiment, when the vehicle speed of the subject vehicle HV is not within the threshold range, the operation of the prediction unit 415 is prohibited. Therefore, it may be possible to reduce the wasteful calculation load while reducing the interference in the communication range of the access point of the wireless network.

### Sixth Embodiment

In the above-described embodiment, the configuration in which the target network is a Wi-Fi network has been described. However, the configuration is not necessarily limited to this. The target network may be another wireless network as long as it is a wireless network that can be connected by wireless communication with the access point within the communication range of the access point. For example, the configuration that the target network is a 5G wireless network or the like may be employed.

It should be noted that the present disclosure is not limited to the embodiments described above, and various modifications are possible within the scope indicated in the claims, and embodiments obtained by appropriately combining technical means disclosed in different embodiments are also included in the technical scope of the present disclosure. The controller and the method thereof described in the present disclosure may be implemented by a special purpose computer which includes a processor programmed to execute one or more functions executed by a computer program. Alternatively, the device and the method thereof described in the present disclosure may be implemented by a special purpose hardware logic circuit. Alternatively, the device and the method thereof described in the present disclosure may be implemented by one or more special purpose computers configured by a combination of a processor executing a computer program and one or more hardware logic circuits. The computer program may also be stored in a computer-readable non-transitory tangible storage medium as instructions to be executed by a computer.

Here, the process of the flowchart or the flowchart described in this application includes a plurality of sections (or steps), and each section is expressed as, for example, S1. Further, each section may be divided into several subsections, while several sections may be combined into one section. Furthermore, each section thus configured may be referred to as a device, module, or means.

1. A wireless communication control device configured to control a wireless communication device that is mounted on a vehicle and is configured to transmit and receive information via wireless communication with an access point of a wireless network, the wireless communication control device comprising:
a vehicle speed acquisition unit configured to acquire a vehicle speed of the vehicle;
a communication status acquisition unit configured to acquire communication status information regarding a communication status in a communication range of the access point; and
a prediction unit configured to predict a communication environment in the communication range of the access point based on the communication status information acquired by the communication status acquisition unit,
wherein
the prediction unit predicts the communication environment when the vehicle speed acquired by the vehicle speed acquisition unit is within a threshold range, and
the prediction unit does not predict the communication environment when the vehicle speed acquired by the vehicle speed acquisition unit is not within the threshold range.

2. The wireless communication control device according to claim 1, wherein
the communication status acquisition unit does not acquire the communication status information when the vehicle speed acquired by the vehicle speed acquisition unit is not within the threshold range.

3. The wireless communication control device according to claim 1, wherein
the threshold range is defined by a plurality of threshold values,
the plurality of threshold values includes an upper limit value and a lower limit value, and
the threshold range is equal to or less than the upper limit value, and also is equal to or more than the lower limit value.

4. The wireless communication control device according to claim 1, wherein
the threshold range is defined by a threshold value,
the threshold value is either an upper limit value or a lower limit value,
the threshold range is equal to or less than the upper limit value when the threshold value is the upper limit value, and
the threshold range is equal to or more than the lower limit value when the threshold value is the lower limit value.

5. The wireless communication control device according to claim 1, wherein
a threshold value defining the threshold range is set to be lower as an information amount of information that needs to be transmitted or received by the wireless communication device when there is the information that needs to be transmitted or received by the wireless communication device.

6. The wireless communication control device according to claim 1, wherein
the threshold range is fixed.

7. The wireless communication control device according to claim 1, wherein
the prediction unit does not predict the communication environment when there is no information that needs to be transmitted or received by the wireless communication device.

8. A wireless communication device that is mounted on a vehicle and is configured to transmit or receive information via wireless communication with an access point of a wireless network, the device comprising:
a communication unit configured to perform the wireless communication with the access point; and
a wireless communication control device includes:
a vehicle speed acquisition unit configured to acquire a vehicle speed of the vehicle;
a communication status acquisition unit configured to acquire communication status information regarding a communication status in a communication range of the access point; and
a prediction unit configured to predict a communication environment in the communication range of the access point based on the communication status information acquired by the communication status acquisition unit,
wherein
the prediction unit predicts the communication environment when the vehicle speed acquired by the vehicle speed acquisition unit is within a threshold range, and
the prediction unit does not predict the communication environment when the vehicle speed acquired by the vehicle speed acquisition unit is not within the threshold range.

9. A wireless communication control method that is executed by at least one processor and controls a wireless communication device that is mounted on a vehicle and is configured to transmit and receive information via wireless communication with an access point of a wireless network, the method comprising:
acquiring a vehicle speed of the vehicle;
acquiring communication status information regarding a communication status in a communication range of the access point;
predicting a communication environment in the communication range of the access point based on the acquired communication status information;
predicting the communication environment when the acquired vehicle speed is within a threshold range; and
executing no prediction of the communication environment when the acquired vehicle speed is not within the threshold range.

10. The wireless communication control device according to claim 1, wherein
a processor serves as the vehicle speed acquisition unit and the prediction unit.

11. The wireless communication device according to claim 8, wherein
a processor serves as the communication unit, the vehicle speed acquisition unit, and the prediction unit.
